(19) United States
(12) Patent Application Publication
(10) Pub. No.: US 2009/0287713 A1
(43) Pub. Date: Nov. 19, 2009

(54) SYSTEMS AND METHODS FOR MEASURING ONLINE PUBLIC RELATION AND SOCIAL MEDIA METRICS USING LINK SCANNING TECHNOLOGY

(75) Inventors: Michael Anderson, Carlsbad, CA (US); Ali Behnam, San Diego, CA (US); Olivier Silvestre, Ramona, CA (US)

Correspondence Address: BAKER & MCKENZIE LLP;PATENT DEPARTMENT, 2001 ROSS AVENUE, SUITE 2300, DALLAS, TX, 75201, US

(73) Assignee: Tealium, Inc., San Diego, CA (US)

(21) Appl. No.: 12/122,617

(22) Filed: May 16, 2008

(51) Int. Cl. G06F 17/30

(52) U.S. Cl. 707/10; 707/E17.01

(57) ABSTRACT

A method for measuring Public Relations (PR) outputs and social media efforts on a webpage is described. The method can comprise generating a list of website addresses, deploying link scanning on the web page, the link scanning configured to include the list of website addresses, and reporting the results of the link scanning to a reporting server.

### BACKGROUND

1. Technical Field

The disclosures herein relate to measuring the performance of online public relations (PR) and social media efforts, and more particularly, to using link scanning methodology to measure the effectiveness of online conversions.

2. Related Art

It will be understood that today's public relations professionals rely on antiquated measurement methods in order to gauge the effectiveness of their activities. This is the case in both the online arena, as well as other channels. A “conversion” is defined as a site objective and can be in the form of online purchase, online lead form completion, newsletter registration, or other business objectives determined by a public relations professional. In the area of online PR, the effectiveness of such activities is typically measured. For instance, one metric called PR Output, centers around the publications or outlets that end up publishing a given story. For example, if a press release and story is picked up by Wall Street Journal (wsj.com), can be considered a PR Output “wsj.com”.

In some cases a publication outlet (e.g. New York Times—nytimes.com or Wall Street Journal—wsj.com) simply provide a link to an external web site, news article, or other web address. PR professionals can measure the PR Output, by tracking the “referring Uniform Resource Locator (URL)”, also referred to as a “referring web address”. This can be done when the visitor is on the article page and clicks on the link. Because of the presence of the direct link, existing Web analytics solutions can detect the referring source as the article page and communicate the results to the PR or marketing teams. However, this method is limited in that only the immediately preceding link (the referring link) may be identified by the Web analytics solution.

Therefore, in cases where there's a story that's been picked up by an online publication or outlet and there's no direct link within the story page that the visitor can click on, it is not possible for PR professionals to determine the “referring URL”, and therefore can not know whether those who read the article have responded favorably by entering their Web site and ultimately converting on the site.

It will also be understood that certain algorithms can be used to perform link scanning. Link scanning is a JavaScript technology through which one can find if a web site visitor has previously visited another page or not. By default, an internet browser (e.g. MICROSOFT INTERNET EXPLORER) assigns a color to each link on a web page based on, e.g. style sheets embedded in the HTML documents. This color link varies whether the link has been visited by the end user. For instance an unvisited link can have a color attribute of blue, whereas a visited link can have a color attribute of purple. This color attribute is present regardless of whether that link is viewable to a website user or if it is invisible to the user. A link can be made invisible if it is embedded into a JavaScript file attached to the HTML web page. By scanning the color attribute of each link, a correlation can be made to determine which links in a web page a web user has previously visited.

PR professionals often want to provide accurate measurements of the online PR activities. Today, this is done using a number of different methods. In cases where the news story provides a direct link to client site, then the referring traffic can be captured using Web analytics tools such as WebTrends, Omniture, Google Analytics, etc. However, many news organizations may fail to provide a direct link in their story. Some PR professionals rely on the use of statistical methods to understand the correlation between the news coverage and the site traffic and conversion. Obviously, this method does not provide the full answer, because in many cases the ultimate reference will be unknown to the current analytic packages.

Alternatively, some PR professionals use surveys by asking their customers or site visitors whether they've been exposed to news stories or PR campaigns. However, surveys have many short comings. These surveys provide results only on a sample of visitors, and they are time consuming to conduct. The PR measurement methodology using embodiments described herein can provide a more comprehensive solution than all of these alternatives.

### SUMMARY

Systems and methods for implementing link scanning technology to measure the effectiveness of online PR are described below. In certain aspects, regardless of whether or not there's a direct link to the Web site on an article page, the effectiveness of online PR can be measured.

In one aspect a method for measuring PR output on a webpage is described. The method can comprise of generating a list of website addresses, deploying link scanning on the web page, the link scanning configured to include the list of website addresses, and reporting the results of the link scanning to a reporting server.

In another aspect a system for measuring PR output on a webpage is described. The system can comprise a data file configured to contain a list of web site addresses, a web page in communication with the data file, the web page configured with link scanning, and a data aggregation server in communication with the web page, the data aggregation server configured to receive the results of the link scanning.

In some embodiments, depending on the network configuration, various servers, databases, files, and applications described herein can be separate components located on or comprising separate servers. However, in other embodiments these components may be integrated together in various configurations. For instance the content server may be located on the same physical device as the link scan tracking database. Furthermore, depending on the requirements of the system and the network configuration, arrangements of these devices can include multiple servers with separate functionality and mirrored servers for redundancy and load balancing.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a flowchart illustrating a method for measuring an occurrence a PR output, according to one embodiment.

FIG. 2 is a flowchart illustrating a method for measuring a PR output from news aggregators, according to one embodiment.

FIG. 3 is a flowchart illustrating a method for measuring a PR output from blogs, according to one embodiment.

FIG. 4 is a flowchart illustrating a method for measuring a PR output from competitive insights, according to one embodiment.

FIG. 5 is a flowchart illustrating a method for measuring a PR output from advertising campaigns, according to one embodiment.

FIG. 6 is a diagram illustrating a link scanning system, according to one embodiment.

FIG. 7 is a flowchart illustrating a method for measuring a PR output from online videos, according to one embodiment.

### DETAILED DESCRIPTION

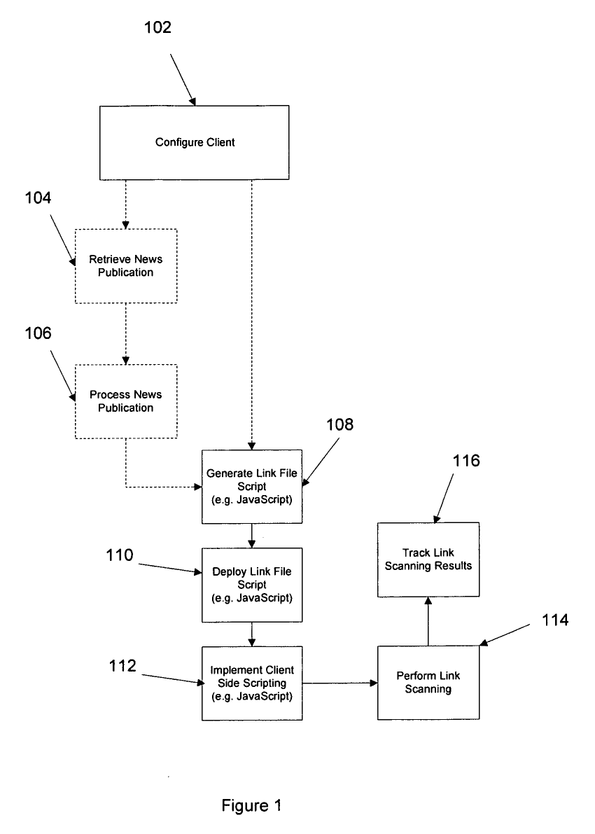

FIG. 1 is a flowchart illustrating a method of measuring an occurrence a PR output, according to one embodiment. In step 102, client configuration can take place. During this step, a list of e.g. keywords, terms, phrases, collection of news publications URLs, or any other list of URLs can be generated. This list can be generated by various methods, e.g. it can be entered into a vendor hosted web page or by using a configuration text file that is uploaded to a vendor hosted server.

The entries in the configuration list, i.e., the feed configuration, can be in Extensible Markup Language (XML) language and can contain data points such as a unique identifier, a URL, a search term, report classification, etc. A unique identifier can be a numeric identifier that uniquely defines the feed for the client. This data point can be stored in a name element. A source data point can contain a short description of product and source of the publication URLs. A source data point can be stored in the format “product.source”. For instance, in the following sample configuration, the value “pr.gn” corresponds to the “PR Tracking” product and “Google News” as the source of the publication URLs. This data point can be stored in the source.name element. A term can refer to the keyword or phrase to determine which news publication URLs should be returned by the source of the publication URLs. This data point can be stored in a term element.

A report classification can be configured to store a user defined categorization for reporting purposes. XML is one method a report can be used to define a categorization, e.g. below is a sample XML configuration:

<feeds>
<feed>
   <name>1</name>
   <source.name>pr.gn</source.name>
   <term>Tealium</term>
   <classification>Company</classification>
</feed>

</feeds>

URL retrieval can then occur in step 104. This step can be optional depending on the method of client configuration step 102 (e.g. a complete URL list is entered or uploaded in step 102). In one embodiment, step 104 can be the retrieval of news publications. However, it should be understood that the publication retrieval is not limited to only news outlets. Information can be gathered from any number of sources (e.g. news outlets, video sites, web blogs, user forums, social networking sites, video feed sources, etc.). During a news publication retrieval step 104, a script or program can be used to automatically generate a list of URLs based on criteria obtained during the client configuration in step 102. For instance, in step 104 publication information can be retrieved that can include the publication URL, title, and publication date from e.g., news outlets. This publication information can refer to any recent publications that contain the terms input in the client configuration step 102.

The new publication retrieval process 104 can, for instance, utilize “Really Simple Syndication” (RSS) feeds from sources such as “news.google.com”. One method these feeds can be retrieved is by issuing an HTTP GET request. This can be done by replacing the ##TERM## value in the following URL with the desired term:
http://news.google.com/news?ie=UTF-8&amp:oe=utf8&amp:h1=en&amp:output=rss&amp:q=##TERM##

The response of this request will be the actual RSS feed response. This response can then be parsed by a retrieval script. A sample RSS item is listed below.

<item>
<title>Israel Bombs Hamas Prime Minister&#39;s Office in Gaza—Voice of America</title>
<link>http://news.google.com/news/url?sa=T&ct=us/0-1-0&fd=R&url=http://voanews.com/english//2008-03-02-voa11.cfm&cid=1132516241&ei=EvnKR4PPGZ_eqwPo7rTSCw</link>
<category> Top Stories</category>
<pubDate>Sun, 02 Mar 200816:25:53 GMT</pubDate>

</item>

Once retrieved, the RSS feed items can be processed in a manner such as that described in step 106, processing publication information. For instance, if a news publication source was retrieved in step 104, in step 106, the publication URL, title, publish date, and other meta data can be processed. Processed data can then be stored, for instance, written to an internal publication database. Each new publication can also be assigned an internal unique identifier. Thus, any publication which previously existed within the publication database can be ignored.

After the information processing step 106 has been performed a link file can be generated in step 108. If the retrieval step 104 and the processing step 106 were not necessary due to the specific client configuration in step 102, the JavaScript link file can be generated in step 108 directly after step 102. Step 108 is described with respect to the creation of a JavaScript link file, however it should be understood that this could be any file that contains the list of link files generated in either step 102 or step 106, and is not limited solely to a JavaScript link file.

During the JavaScript link file generation step 108, a program can use the retrieved the list of URLs from the appropriate source generated in step 106. The source will vary from one application to the next. For instance, a vendor-hosted program can retrieve the publication information from the publication database in order to generate a JavaScript file that can contains each publication URL and unique internal identifier. Once retrieved, the program can generate a file (e.g. JavaScript file) that includes the links and their identifier. In one embodiment, this file can be stored in a compressed format where the longest repeated strings are substituted for a lookup value. For example, almost all links that are to be scanned are going to start with the term “http://”. This string of 7 characters can instead be replaced with a shorter string in order to save space and therefore download time.

After the JavaScript link file generation, step 108, the link file deployment, step 110, can occur. Again, this step is described with respect to a JavaScript link file deployment, however the descriptions herein are not limited to JavaScript. During this step, the file that contains the collection of publication URLs and unique internal identifiers can be transferred to a web server where it can be publicly available to web browsers on the internet. This will typically be handled via SFTP to a content delivery network or directly to the client's web server farm.

Step 112 is described with respect JavaScript, however the descriptions herein are not limited to JavaScript. Referring to step 112, JavaScript client implementation, web pages that wish to utilize the PR tracking functionality must include specific JavaScript code in order to analyze whether or not a web browser has visited any of the publication URLs. To handle this, the required link scanning JavaScript source code can be included in the web pages hosted by the client. This could be embedded directly in a client webpage or linked in via a reference to a file containing the source code (e.g. an include statement). This JavaScript client implementation can occur in step 112.

Referring to step 114, visited link can be scanned. When a client web page is viewed by a web browser, and the client web page includes the JavaScript client implementation, the collection of publication URLs can be used to create non-visible anchor tags within the HTML content. A link style can be created for the visited style attribute for anchor tags, and a specific color can be assigned to this style. This link style can be created as a specific style class ID. For each publication URL an anchor tag can be added to the html document. The “HREF” attribute of each anchor tag can be set to the value of the publication URL, and the “ID” attribute of each anchor tag can be set to the link style class ID. As the links are created the color property of the anchor tag can be read and if it matches the color used for the visited link style, then this can indicate that the corresponding publication URL has been visited by the web browser. If the color attribute does not match the visited link style then this can indicate that corresponding publication URL has not been visited.

Referring to step 116, the visited link can be tracked. Upon completion of scanning the visited links 114, information to indicate which publication URLs were visited and which publication URLs were not visited can be stored for later use. The scope of the data collection system can vary from one application to the next, and the descriptions herein are not limited to any one method to store the results. For instance, in one embodiment, the results can be exported to a custom data collection tool. In another embodiment the results can be exported to a existing web analytics application, so that one can integrate the visitor's onsite clickstream activity with their past activity prior to arriving to site. In another embodiment, this data can be stored in a client side cookie or a server side cookie. This data can also be stored in a server side database and/or transmitted to a data collection system as described above. The use of cookies, or a server side database allows the ability to profile a visitor on subsequent visits even if their browser cache has been deleted. Additionally, multiple storing methods can be used, e.g. the list can be added to a web browser cookie via JavaScript and also submitted to server side storage device (e.g. a database).

The information stored may also vary based on a specific implementation. For instance, the information can be stored as a list of publication URL ids. The publication URL ids can be tracked in an analytics program if exported to such a program.

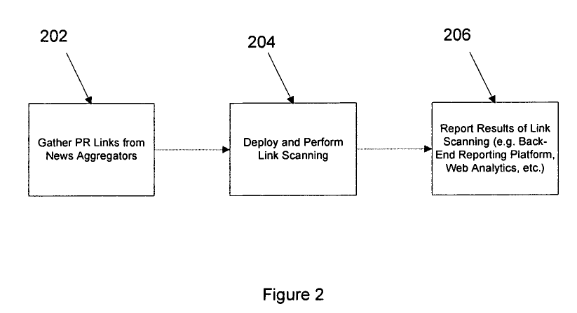

FIG. 2 is a flowchart illustrating a method of measuring a PR output from news aggregators, according to one embodiment. Referring to FIG. 2, link scanning technology can be used to determine whether a site visitor has previously been exposed to a news story about the company. This can be extremely useful for a company spending a lot of money generating press releases and news coverage about their products and services. Unfortunately today, there's no way to link the news coverage (referred to as PR output) to site visit or conversion (referred to as PR outcome).

A link scanning process, as described in one embodiment herein, can makes this possible. In step 202, the PR links can be culled from news aggregators. Step 202 can include the various steps 102 through 112 as illustrated in FIG. 1. For instance, a list of PR or news stories can be gathered from news aggregator sites (such as Google News or Yahoo News). This data feed can be parsed and transformed from such services to a list of URLs that can be embedded in a JavaScript file. In step 204, link scanning can be implemented to detect the PR links culled from news aggregators. In step 206, these results can be entered into a reporting platform or web analytics package, to analyze the aggregated results. The reports generated from the aggregated date can provide detail correlating the amount of traffic generated on site by those who've been exposed to online news stories about the company, as well as number of conversions by these people. This can be useful to PR professionals who want to provide an accurate measurement of their online PR activities, and is much more flexible than any current methods.

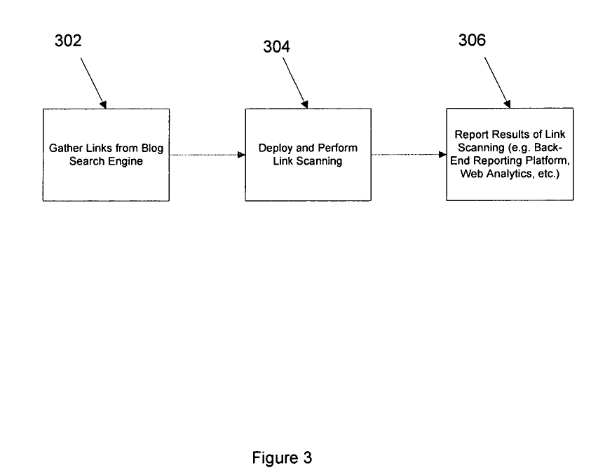

FIG. 3 is a flowchart illustrating a method of measuring a PR output from blogs, according to one embodiment. Similar to PR measurement described in FIG. 2, link scanning can be used to cull URLs and/or other target data from blogs rather than news outlets to determine whether the visitor has previously visited a specific page or blog. As bloggers cover topics about a company, blog search aggregators such as Google archive these discussions. Step 302 can include the various steps 102 through 112 as illustrated in FIG. 1. Referring to FIG. 3, in step 302, URLs can be extracted from blog search engines such as Google, and these links can be added to a file such as a JavaScript file.

In step 304, link scanning can be used from the data gathered in step 302. In step 304, a reporting platform or web analytics platform can be used to culminate and evaluate the data to determine the effectiveness of the blogs. The reports generated can then cover the amount of traffic generated on site by those which has been exposed to blog stories about the company, as well as number of conversions by these people. The can be essential to PR and marketing professionals who want to provide a reliable measurement of blog coverage about their company. The only alternative available today, is to monitor blog coverage (who's blogging about the company and whether the blog contribution is positive or negative). However, this is not able to provide a quantitative way of measuring the effect of blogs on site traffic and conversion.

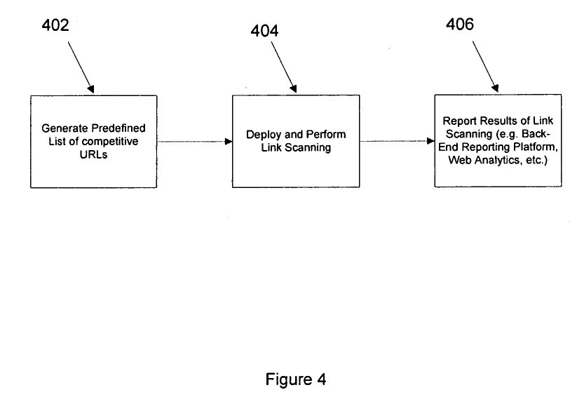

FIG. 4 is a flowchart illustrating a method of measuring a PR output from competitive insights, according to one embodiment. Step 402 can include the various steps 102 through 112 as illustrated in FIG. 1. Referring to FIG. 4, in step 402 a list of competitive URLs (e.g. a list of competitor's websites, or a list of URLs containing competitive products) can first be generated and written to a file (e.g. a JavaScript file) which can be used for link scanning. Once a visitor enter into a site containing, link scanning, the link scanning can scan the visitors against this list to determine which competitive sites have been visited, step 404. The matching information is then sent to either a reporting tool or a web analytics package which can be configured to analyze the data and generate reports, step 406. The resulting statistic reports can for instance show what percentage of site visitors previously visited a competitor site or product, and allow PR professional an ability to convert these visitors much more effectively than conventional methods.

These statistical reports can assist marketing professionals and site managers optimize their Web site. They can use this information to fine tune the information provided to Web site visitors. The only alternative to getting this type of reporting today is to rely on a panel based web analytics company (e.g. NetRatings and comScore). However, because these solutions are reliant on panels, they're often found to be inaccurate and limiting based on the information that they provide. These companies recruit an audience for their panels and because of their value proposition; their panel sample is often biased towards home users, and are hardly an representation of business users. These panels represent a very small sample of the actual audience and therefore can at the very best be used by sites with a very high level of traffic.

Another embodiment described herein can involve the use of the link scanning technology to change the content of the web site or web page. Although some embodiments described herein require passing the results into either a reporting back-end or a Web analytics package so that the data can be correlated with other web site behavior data. However, in some embodiments this last step is not required, and instead the results of the link scanning operation may be used by a subsequent web page viewed by the browser, typically in the form of change of content.

For instance, upon browsing to an automotive site such as autotrader.com, the link scanning technology can be applied to determine which auto sites the visitor has previously been to. For instance, if the visitor has been to a BMW site, the content can be changed to show a BMW banner and similarly if the visitor has been to a Nissan web site, the content can be changed to fit the profile.

In another example, for instance, if a web site is selling a software package for $249, but the closest competitive product sells for $225, upon entering the web site, link scanning technology can be applied to determine if the visitor has been to the competitor site. If so, then the price can dynamically be changed.

In a content targeting embodiment, a list of URLs should first be defined for targeting purposes, such as competitive sites or other sites within the same industry. Then link scanning technology should be deployed and used as described in steps 108 through 114. However, then instead of simply tracking the link scanning results, the HTML content of the web page (or a subsequent webpage) can be changed, based on the link scanning result. Of course, optionally this information could still be tracked as described above with respect to step 116. The HTML content to be changed could be, for instance, an image, text, price offer, or the page itself.

The concept of changing the HTML content based on a criterion has been used in behavioral targeting platforms. These tools include Touch Clarity, Kefta, Certona and others. However all previous implementations rely on using existing site data for behavioral targeting purposes. This means that the site needs to have historical information about the visitor in order to be able to provide a personalized experience (e.g. the visitor has to have visited the site before). Thus, the embodiments describe herein have a significant advantage in that by integrating link scanning technology, the web browsing experience of first time visitors may be “personalized”, because there is no historical perspective requirement of the visitor.

Another embodiment described herein involves profile based targeting. Profile based targeting involves the use of the link scanning technology to build a profile of the visitor that can then be used for targeting purposes. The targeting component can be in the form of an advertisement or content on a web page. This application is different than the “Content Targeting” application in that the profiles are pre-defined based on industry verticals, allowing a more inclusive profiling technology across many sites.

As an example, consider a visitor entering an advertising site such as cnn.com. Upon landing on the page, the link scanning technology can be deployed to profile the visitor based on the industry that they're most likely to respond to. For example their previous visit to the sites cars.com, autotrader.com and kbb.com indicates their shopping tendency for automobiles, whereas their previous visit to the sites news.com, cnet.com and pcmag.com indicates their likelihood to respond to computer-related content and advertising. This information can be used to target the visitor with appropriate content or advertising.

To accomplish this profile based targeting, first the list of profiles or industries must be defined. This can be done through a client configuration similar to that described in step 102. Then link scanning technology should be deployed and used as described in steps 108 through 114. Similar to the previous example, HTML content or banner advertising can then be changed based on the link scanning result. The HTML content to be changed could be an image, text, price offer, or the page itself

There are currently a number of companies that are providing targeted advertising based on where visitors have been before. These companies include Tacoda, Revenue Sciences and Blue Lithium. However, they require an expensive infrastructure. First, they require having a JavaScript tag on pages of all clients within their network. There is therefore an aggressive push by all of these companies to have their JavaScript tags on as many sites as possible. Second, all data is sent to a data center, where the massive amount of data is analyzed and used for profiling and targeting purposes. The use of link scanning to achieve this bypasses both needs (no requirement for other sites to be coded with a special JavaScript tag, and no requirement for extensive data warehousing).

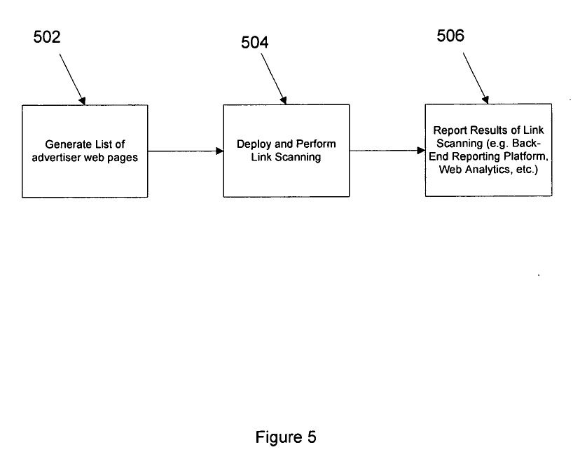

Yet another embodiment described herein relates to advertising discovery. FIG. 5 is a flowchart illustrating a method of measuring a PR output from advertising campaigns, according to one embodiment. Conventional online advertising practices involve results-driven processes following lots of trial and error steps. They are results-driven because online advertising can easily be measured using either campaign management tools (e.g. DoubleClick, Unica) and Web analytics tools (Omniture, Coremetrics, WebTrends, etc.). However, there is still a great deal of trial and error involved because there's no way for online marketers to know what sources best work for them unless they test these sources.

Consider this example: a marketing manager for an automotive site has a $100,000 advertising budget. He wants to target visitors from autotrader.com, kbb.com, edmunds.com, cars.com and carsdirect.com and Yahoo Cars. Unfortunately, with his budget, reaching all these sources is impossible. He could make an education guess on which sources will have the best potential. Unfortunately, this is only a guess and is not going to necessarily yield the best result.

Referring to FIG. 5, advertising discovery method can involve the use of link scanning to simulate the situation where an advertising campaign is being conducted on all considered sources. In step 502, a list of potential advertiser's websites can be generated and stored in a file (e.g. JavaScript file). Step 502 can include the various steps 102 through 112 as illustrated in FIG. 1. In step 504, this JavaScript file can be integrated in a link scanning deployment. As described, link scanning can detect a visitor's previously visited URLs. In step 506, the results can be entered into a web analytics or back-end reporting system and these systems can be configured to generate statistical analysis. This analysis can, for instance, be used to profile users of a website to determine which websites naturally draw the target audience. Since all possible advertising websites can be identified and tested against, the statistical analysis of this data can determine which URLs that have previously been visited in order to predict the best possible advertising destinations (in terms of potential conversion rate for the site).

There is currently no solution that provides this level of information. However, previously mentioned panel-based data providers such as comScore and NetRatings can provide some data similar to this using custom algorithms/engagements. However, as mentioned, because their solutions are panel-based, their reports will be inaccurate and not representative of the total Web site audience. Embodiments described herein, however, can be quicker, easier, more accurate, and able to provide this insight on the full range of site visitors.

Another embodiment can involve online lead quality assessment. Online lead quality assessment involves the use of link scanning to provide quality data about online leads. An online lead is defined as a visitor that fills out a form on a Web site. Not all sales happen on the Web site. Many businesses rely on their sales force to close deals. These companies use the Web site as a lead generation mechanism. Once the lead is captured online, it is then distributed to the sales team. For this reason, the more data they can capture about the visitor, the more educated their sales team becomes.

One data point that can help the sales team is to know what competitors the prospect is considering. One way to capture this data is to ask the prospect the question, but often the prospect will not share this data. The use of link scanning therefore involves getting this data point from the visitor's browser.

For example, a list of competitive sites and pages can fed into the link-scanning algorithm (as described with respect to steps 102-112 above). This can be done by first defining the list competitive web pages that you'd like to know if the visitor has been (as described with respect to step 102). These could include product pages and web site confirmation pages. A competitive web site confirmation page can mean that the prospect has also contacted your competitor. These are then scanned on the form page (as described with respect to step 114), for instance, when the visitor enters their name and contact information. The processed information (which links has the visitor previously been to) can then be written to a hidden form field on the form page and submitted to the company, for instance, when the visitor clicks the “Submit” button. Pushing the resulting link scan data to a hidden form field can enable a sales team to utilize this data point during the sales process. This link scan result information can also be stored as described with respect to step 116 above.

Currently, the only way to get this solution is simply asking the prospect and the prospect may choose to not share this information. This is valuable information for a sales team since they can fine-tune their messaging by pitching features and benefits that can compete better with specific competitors.

Another embodiment described herein relates to employee behavior tracking. Employee behavior tracking can involve the use of link scanning to get information about the internet usage of employees. The application is as follows: on a page that can only be accessed by your employees (such as your company intranet), deploy the link-scanning technology and scan against web pages that should not be visited by the employees. For example, these could be pornographic web pages, personal email pages (such as Yahoo Mail, Hotmail and Gmail), job search pages (making sure that employees are not applying for other positions using company equipment), or whatever websites an administrator dictates.

These undesirable websites can first be inputted as described in step 102, to define the list of forbidden pages (URLs). Then link scanning technology should be deployed and used as described in steps 108 through 114. The link scanning webpage can then be displayed on a page that can only be accessed by employees (such as your intranet) and link scanning can be performed as described in step 114. The resulting data can be stored as described in step 116, and can then be fed into a reporting tool or a Web analytics solution. The information derived can inform, for instance, whether any employees are going to a forbidden page.

There are a number of solutions that currently provide this information. One prominent company in this field is WebSense. These companies have solutions that track employee Internet and email usage directly from the computer and the corporate network. The advantage of the link scanning technology is that it can provide the information even if the employee was not on the company network. For example, an employee can get a corporate laptop and connect it to his/her home network. In this case, products such as WebSense do not provide tracking, because the user is not on the corporate network when the browsing occurs. However. because these pages are cached into the browser, link scanning technology can generate the desired information the next time the employee connects to the employee portal or intranet.

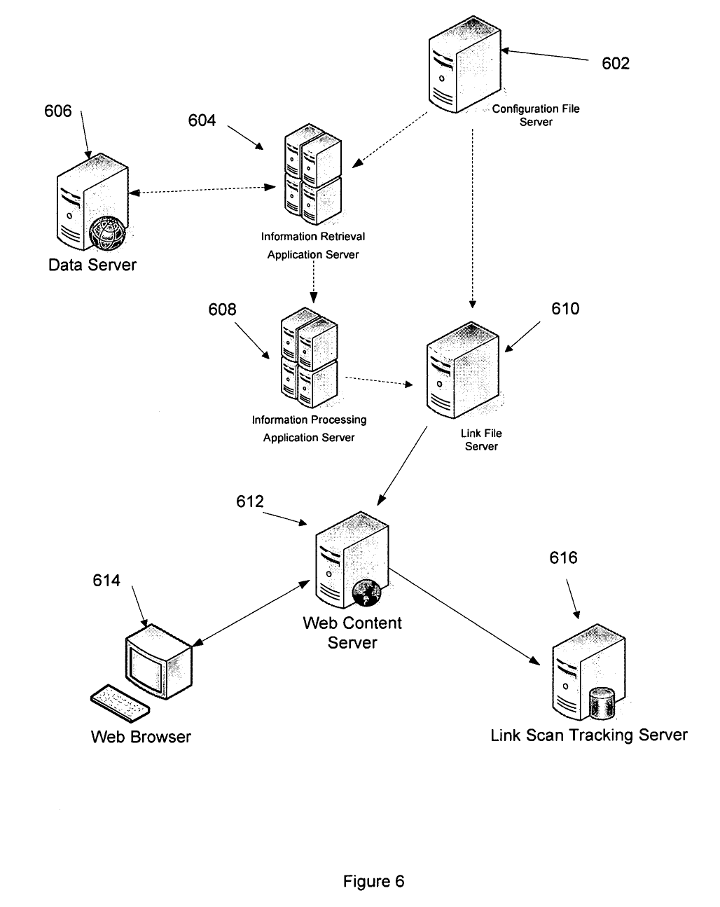

FIG. 6 is a diagram illustrating a link scanning system, according to one embodiment. The descriptions herein refer to various servers in the link scanning system. Although not explicitly depicted in FIG. 6, one of ordinary skill will recognize that there are numerous functionally equivalent techniques to create, manage, store, and serve configuration files, publication content, result files, user content, software. Included in these techniques are methods to ensure security, data integrity, data availability and quality of service metrics. Thus, it should be apparent to one of skill that the servers described can be physically separate or may be integrated. Additionally, the various servers may span multiple devices or mirrored amongsts many servers.

Referring to FIG. 6, a configuration file server 602, can contain a client configuration file. The client configuration file can contain keywords, terms, phrases, collection of news publications URLs, or any other list of URLs be generated. The client configuration file can be stored in various means (e.g. a flat file, a database file, a JavaScript file, etc) on the client configuration file server 602.

In one embodiment, the client configuration file can be in communication with an information retrieval application server 604. The information retrieval application 604 can interact with a data server 606 (e.g. a news publication system, a blog search engine, a video feed system, a webpage, etc.), and can be configured to retrieve information as described in step 104 (e.g. from a news publication RSS feed). In turn, the information retreival application server 604 can be in communication with an information processing application server 608. The information retreival application server 604 can thus request information from the data server 606, based on the configuration file stored in the configuration file server, and transmit the results to the information processing server 608. The information processing server 608 can be configured to process the information returned from the data server 606 either directly (not shown) or via the information retreival application server 604. The information processing application server 608 can process the information returned by the information retrieval application 604, as described in 106, and generate a link file as describe in 108. The link file 610 can reside in the link file server 610. The link file server, may be a database or other storage device. Additionally, the link file server 610 may be integrated with other server as dictated by the network structure.

Alternatively, a complete list of URLs can be contained in the configuration file stored in the configuration file server 602. The configuration file can be stored directly into the link file 610 by the methods described above.

The link file server 610, can be configured to deploy the link file, as describe in step 110, and the file that contains the collection of publication URLs and unique internal identifiers can be transferred to a web server 616 where it can be publicly available to web browsers on the internet.

The web server 616, can be in communication with the link file server and can implement the client scripting (e.g. JavaScript), as described in step 112, to analyze whether or not a web browser has visited any of the publication URLs. To handle this, the required link scanning scripting source code can be included in the web pages hosted by the webserver.

When a web browser 618, requests a web page on the web content server 616, a webpage with the link scanning scripting can be transmitted from the web content server 616 to the web browser. As described in step 114, when a client web page is viewed by a web browser, and the client web page includes the scripting client implementation, the collection of publication URLs can be used to scan the links a web browser has been to. After link scanning has been performed on the web browser the results of the link scanning can be transmitted to the web content server 616, and can then be transmitted to the link scan tracking storage device 620, as described in step 116. Furthermore, the link scan tracking server 620 can also be located on the same server or integrated with the web content server 616. As described above in step 116, the link scan tracking server 620 may communicate or be integrated with such devices as a database, a back-end reporting server, or a web analytics package. Furthermore, a reporting server (not shown) can be configured to generate a statistical report based an aggregation of results from link scanning operations performed on multiple web browsers.

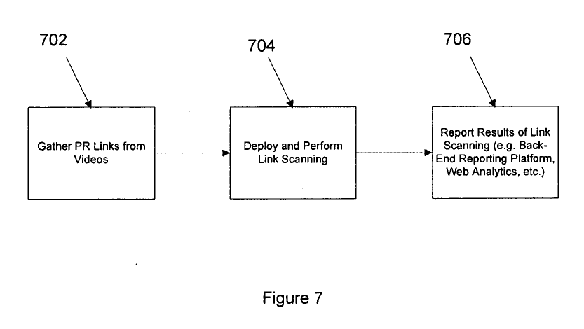

FIG. 7 is a flowchart illustrating a method of measuring a PR output from videos, according to one embodiment. This embodiment can function similar to that of the PR measurement method described in FIG. 2. Hence, link scanning can be used to cull URLs and/or other target data from video sites rather than news outlets to determine whether the visitor has previously viewed a specific video page. Referring to FIG. 7, in step 702, the PR links can be culled from video sites. Step 702 can include the various steps, e.g. 102 through 112 as illustrated in FIG. 1. For instance, a list of videos can be gathered from an aggregator sites such as Google Video. This data feed can be parsed and transformed from such services to a list of URLs that can be embedded in a JavaScript file. In step 704, link scanning can be implemented to detect the video links culled from video aggregators. In step 706, these results can be entered into a reporting platform or web analytics package, to analyze the aggregated results. The reports generated from the aggregated date can provide details correlating the amount of traffic generated by those who've been exposed to a given video.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. In a system comprising a configuration file server, an information retreival server, an information processing server, a link file server, a web content server, and a link scan tracking server, a method for measuring PR output comprising:
in the configuration file server,
generating a configuration file, the configuration file configured to store an entry comprising of data points, the data points comprising:
a Uniform Resource Locator (URL) associated with a PR output;
a unique identifier, the unique identifier configured to identify the entry in the configuration file;
a search term, the search term indicating words for use by the information processing server; and
a report classification, the report classification indicating a user defined categorization for reporting purposes;
storing the configuration file on the configuration file server; and
communicating the configuration file to the information retreival server,
in the information retrieval server;
receiving the configuration file;
requesting information from a data server based on the received configuration file; and
communicating the results from the information request to the information processing server;
in the information processing server,
receiving the requested information;
processing the requested information to generate a list of link file URLs; and
transmitting the list of link file URLs to the link file server,
in the link file server,
receiving the transmitted list of link file URLs;
storing the list of link file URLs;
generating a link scan file script, the link file script comprising the links and the unique identifier; and
deploying the link scan file script to the web content server;
in the web content server,
implementing client side scripting onto a web page;
receiving a request from a web browser for the web page;
communicating the web page to the web browser;
receiving the results of the link scanning script performed by the web browser; and
transmitting the results of the link scanning script to the link scan tracking server;
in the link scan tracking server,
receiving the results of the link scan script; and
storing the results of the link scan script.

2. The method of claim 1, wherein the data server is a news publication server.

3. The method of claim 1, wherein the data server is a news publication retrieval service.

4. The method of claim 1, wherein the data server is a blog search engine.

5. The method of claim 1, wherein the data server is a video search engine.

6. The method of claim 1, wherein the data server is a website.

7. The method of claim 1, wherein the requested information is provided in a Really Simple Syndication (RSS) feed.

8. The method of claim 1, further comprising: in the link file server, compressing the size of the link scan file by substituting common character strings for a lookup value.

9. The method of claim 8, wherein the link scan file is a JavaScript file.

10. The method of claim 1, wherein the reporting server is in communication with back end reporting software.

11. The method of claim 1, wherein the reporting server is in communication with web analytics software.

12. In a system comprising a configuration file server, a link file server, a web content server, and a link scan tracking server, a method for measuring PR output comprising:
in the configuration file server,
generating a configuration file, the configuration file configured to store an entry comprising of data points, the data points comprising:
a Uniform Resource Locator (URL) associated with a PR output; and
a unique identifier, the unique identifier configured to identify the entry in the configuration file;
storing the configuration file on the configuration file server; and
communicating the configuration file to the link file server,
in the link file server,
receiving the configuration file;
generating a link scan file script, the link file script comprising the URL and the unique identifier;
deploying the link scan file script to the web content server;
in the web content server,
implementing client side scripting onto a web page;
receiving a request from a web browser for the web page;
communicating the web page to the web browser,
receiving the results of the link scanning script performed by the web browser, and
transmitting the results of the link scanning script to the link scan tracking server;
in the link scan tracking server,
receiving the results of the link scan script, and
storing the results of the link scan script.

13. The method of claim 12, further comprising: in the link file server, compressing the size of the link scan file by substituting common character strings for a lookup value.

14. The method of claim 13, wherein the link scan file is a JavaScript file.

15. The method of claim 12, wherein the reporting server is in communication with back end reporting software.

16. The method of claim 12, wherein the reporting server is in communication with web analytics software.

17. In a system comprising a configuration file server, a link file server, a web content server, and a web browser, a method for profile based targeting comprising:
in the configuration file server,
generating a configuration file, the configuration file configured to store an entry comprising of data points, the data points comprising:
a Uniform Resource Locator (URL) associated with a PR output; and
a unique identifier, the unique identifier configured to identify the entry in the configuration file;
storing the configuration file on the configuration file server; and
communicating the configuration file to the link file server,
in the link file server,
receiving the configuration file;
generating a link scan file script, the link file script comprising the URL and the unique identifier;
deploying the link scan file script to the web content server;
in the web content server,
implementing client side scripting onto the web page;
receiving a request from a web browser for the web page;
communicating the web page to the web browser,
receiving the results of the link scanning script performed by the web browser, and
transmitting the results of the link scanning script to the link scan tracking server;
in the web content server,
running the web page configured to execute the link scan script; and
changing HTML content based on the results of the link scan script;

18. The method of claim 16, further comprising: in the link file server, compressing the size of the link scan file by substituting common character strings for a lookup value.

19. The method of claim 18, wherein the link scan file is a JavaScript file.

20. The method of claim 17, wherein changing the HTML content comprises changing an image.

21. The method of claim 17, wherein changing the HTML content comprises changing text.

22. The method of claim 17, wherein changing the HTML content comprises changing a price of an item displayed on the web page.

23. The method of claim 17, wherein changing the HTML content comprises adding a hidden HTML, the hidden HTML field reflecting the results of the link scan script.

24. The method of claim 17, wherein the system further comprises a link scan tracking server and the method of claim 17 further comprises:
in the link scan tracking server,
receiving the results of the link scan script, and
storing the results of the link scan script.

25. A system for measuring PR output comprising:
a configuration file server configured to generate a configuration file, the configuration file configured to store an entry comprising of data points, the data points comprising:
a Uniform Resource Locator (URL) associated with a PR output;
a unique identifier, the unique identifier configured to identify the entry in the configuration file;
a search term, the search term indicating words for use by an information processing server;
a report classification, the report classification indicating a user defined categorization for reporting purposes,
store the configuration file on the configuration file server; and
communicate the configuration file to an information retreival server;
the information retrieval server in communication with the configuration file server, the information retrieval server configured to receive the configuration file, request information from a data server based on the received configuration file, and communicate the results from the information request to the information processing server;
the information processing server in communication with the information retrieval server, the information processing server configured to receive the requested information, process the requested information to generate a list of link file URLs, and transmit the list of link file URLs to a link file server,
the link file server in communication with the information processing server, the link file server configured to receive the transmitted list of link file URLs, store the list of link file URLs, generate a link scan file script, the link file script comprising the links and the unique identifier, and deploy the link scan file script to the web content server;
the web content server in communication with the link file server, the web content server configured to implement client side scripting onto a web page, receive a request from a web browser for the web page, communicate the web page to the web browser, receive the results of the link scanning script performed by the web browser, and transmit the results of the link scanning script to the link scan tracking server;
the link scan tracking server in communication with the web content server, the link scan tracking server configured to receive the results of the link scan script, and store the results of the link scan script.

26. The system of claim 25, wherein the data server is a news publication server.

27. The system of claim 25, wherein the data server is a news publication retrieval service.

28. The system of claim 25, wherein the data server is a blog search engine.

29. The system of claim 25, wherein the data server is a video search engine.

30. The system of claim 25, wherein the data server is a website.

31. The system of claim 25, wherein the requested information is provided in a Really Simple Syndication (RSS) feed.

32. The system of claim 25, further comprising: in the link file server, compressing the size of the link scan file by substituting common character strings for a lookup value.

33. The system of claim 32, wherein the link scan file is a JavaScript file.

34. The system of claim 25, wherein the reporting server is in communication with back end reporting software.

35. The system of claim 25, wherein the reporting server is in communication with web analytics software.
